(19) United States
(12) Patent Application Publication
(10) Pub. No.: US 2018/0077877 A1
(43) Pub. Date: Mar. 22, 2018

(54) SUPPORTS FOR GROWING AN ORGANISM, USES OF SAID SUPPORTS AND GROWING AND PURIFICATION METHODS USING THESE SUPPORTS

(71) Applicant: SOUS LES FRAISES SAS, Paris (FR)

(72) Inventor: Yohan HUBERT, Paris (FR)

(73) Assignee: SOUS LES FRAISES SAS, Paris (FR)

(21) Appl. No.: 15/564,477

(22) PCT Filed: Mar. 4, 2016
(86) PCT No.: PCT/EP2016/054710

§ 371 Date: Oct. 5, 2017

(30) Foreign Application Priority Data
Apr. 7, 2015 (BE) BB2015/0116

(51) Int. Cl. A01G 9/02; A01G 31/00

(52) U.S. Cl. CPC A01G 9/025; A01G 31/001

(57) ABSTRACT

Porous support for growing an organism, comprising two walls capable of holding water, the two walls being designed to form at least one pocket for holding the organism, characterized in that each wall comprises at least one porous layer comprising a chemically inert and porous material allowing water to flow under the effect of gravity through the pores of the layer, the said layer being designed to allow the organism to cling on to it.

### TECHNICAL FIELD OF THE INVENTION

This invention relates to the growing of plant organisms, fungi or microorganisms (yeasts, bacteria).

More specifically, the invention relates to a porous support for growing an organism comprising two walls to hold water, the two walls being designed to form a pocket for receiving the organism.

### STATE OF THE ART

The patent FR 2 960 384 defines such a support.

However, the walls are connected to each other at the top and at the bottom of the support, on the one hand, and these walls are impermeable to water, on the other hand, so that water is retained in the support and stagnates there. This results in its oxygen supply being disturbed. Moreover, because of the water retention and the permanent humidity of the support, the support walls of this prior art must be entirely comprised of an imperishable material.

The invention of this application aims to compensate for these disadvantages.

To this end, it relates to a support of the type specified above,

characterised in that each one of the two walls comprises at least one layer of a chemically inert and porous material, allowing water to flow through the pores of the layer, the porous layer being designed to allow the organism to cling on to it.

Preferably, the said inert, porous and clinging material layers of the two walls are internal layers.

Because of the water flow outside of the support of the invention and the arrangement of the porous layers, the root system of the organism can be developed, just like populations of fungi or microorganisms, useful for growing plants by facilitating the capture of nutritional elements, in particular, those provided by organic fertilisers, whereas the support of the prior art outlined above only tolerates chemical fertilisers.

Thanks to the combination of water flow and in that roots can cling on to the porous layers of the support walls of the invention, the roots of the organisms are best nourished, on the one hand, and best attached, on the other hand.

It will be noted that the support of this application proceeds with a process that is totally opposite to that which had proceeded with the development of the invention of the prior art above, retention in one case, water flow outside of the support, in particular, outside of root contact zone, in the other case.

Other prior art references are known, but they must be considered as non-relevant.

The document GB 2 454 678 defines a device for plant propagation which comprises plastic material pockets that have an opening at the top, and openings at the bottom to drain the irrigation water, which enables the avoidance of excess fluid. Such a device can be mounted on a vertical wall.

However, such a device does not inform a growth system about a tilted, inert, porous and draining layer.

The document WO 2008/043904 defines the modular wall elements for growing plants, comprising means for hanging plants and a flow vehicle under the effect of gravitational flow of an aqueous, nutritive solution for plants, being presented in the form of a layer covering a support plate. This layer is comprised of a first water retention sheet, likely to allow the rootedness of the plants and a second draining sheet.

Here, it is about rootedness provided in the water retention zone and not at all about an inert, porous and draining material.

This application also relates to the intermediary product of the support above, formed of a draining support to grow an organism comprising one single wall to hold water, characterised in that the wall comprises at least one porous layer of a chemically inert material allowing water to flow through the pores of the layer, the porous layer being designed to allow the organism to cling on to it.

It will be highlighted, that this latest invention is connected to the first one, by a same general inventive concept, which is the inert, porous and draining layer, its characteristic forming the characterising part of the two claims in question, of which the result is the same in the two inventions.

Advantageously, the porous and clinging layers contain biodegradable fibres, intended to initialise the colonies of microorganisms before the organism's roots develop, like for example, hemp or coco fibres.

Advantageously, in the support of the invention with two walls, in each one of the walls, a porous layer, clinging and internal, each wall comprises an external, porous and draining protective layer and, preferably, a third dividing, porous and draining structural holding layer of the wall.

It will again be noted, that the supports of this invention can be irrigated both continuously and intermittently, the water saturation problem not occurring, thanks to the porosity.

The invention also relates to a method of growing aerobic bacteria and/or aerobic fungi comprising:

the preparation of a porous support according to what is defined above,
the seeding of these bacteria and/or fungi and
the adding of a growing environment comprising water and organic nutrients, as well as a method for purifying a composition comprising organic compounds that come from biological waste, comprising:
the preparation of a porous support according to what is defined above,
the seeding of this porous support with aerobic bacteria and/or aerobic fungi and/or plants, and
the adding of this composition to be purified to this porous, seeded support.

The invention will be best understood upon reading the following description, in reference to the appended drawings, whereon

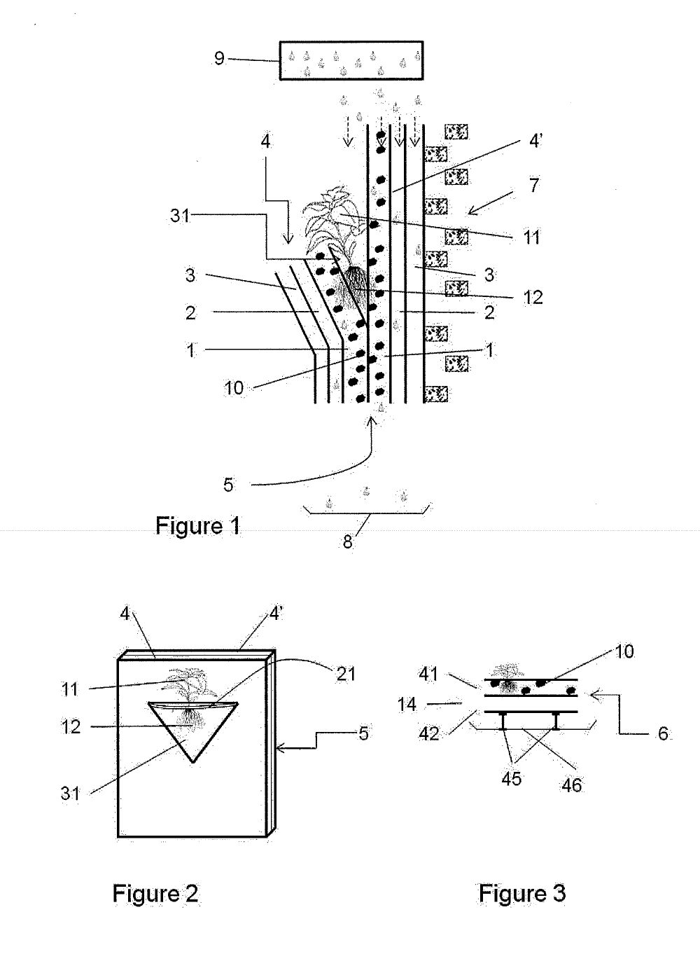

FIG. 1 represents a cross-section view of the two-walled growing support of the invention;

FIG. 2 schematically represents a view of the support face in FIG. 1 and

FIG. 3 represents a cross-section view of the single-walled growing support of the invention.

### DETAILED DESCRIPTION OF THE INVENTION

In reference to FIG. 1, the support 5 for growing an organism 11, here a plant provided with leaves and flowers, comprises two walls 4, 4′ facing each other, each wall comprising an internal, porous layer 1 comprising chemically inert fibres and here a few biodegradable fibres 10, each wall comprises here an external protective layer 3 and a dividing layer, formed of chemically inert, porous fibres 2. The support 5 is attached against a wall 7 by one of its walls 4′, by conventional means, perfectly within the scope of a person skilled in the art. The other wall 4 of the support 5, opposite on the wall 7, has been cut on a horizontal section 21 to be able to remove a part of it, in order to form a pocket 31 for receiving the plant 11.

An irrigation device 9 is provided, above the pocket 31 and, below the pocket 31, a container for collecting the drained water. The water from the irrigation device 9 flows along the support 5 under the effect of gravity through the pores of the layers of the walls 4, 4′. The irrigation system can be a drop-by-drop system or an intermittent system. It will be noted that it is by simplicity and clarity, that a support 5 with one single pocket 31 has been defined. It is naturally easy to provide a support with a plurality, even a large plurality of growing pockets. Here, a totally draining growing support is made use of, in other words, of which the water retention properties are very weak, even non-existent. This enables a better development of the root system 12 of the plant 11 in the draining support 5. That, combined with the presence of pores in the walls 4, 4′ of the support 5, ensures it a better mechanical holding.

Thanks to the low proportion of biodegradable fibres 10 in the draining layers 1 of the porous support 5, here, slowly biodegradable fibres like hemp or coconut fibres, a better colonisation is obtained by fungi and/or microorganisms, in particular aerobic fungi and/or microorganisms, which has a usefulness in itself for the growing of these fungi and/or microorganisms, and improves the metabolism of the roots 12 of the grown plant 11.

Organic fertilisers (here coming from plant waste, other than waste from the grown plant) have been used, the support 5 allowing the presence of aerobic fungi and/or microorganisms.

The internal, draining, porous layer 1 is here produced, mainly, from synthetic fibres, such as polyolefins, in particular, polypropylene.

The fibres forming the internal, porous and draining layer 1 are, mainly, not biodegradable and are chemically inert, at least under the conditions of temperature and pH level, where organisms are grown. These fibres are chemically resistant to the metabolites secreted by the growth or to the substances present in fertilisers. Furthermore, these fibres do not supply nutrients to the grown organisms. However, these fibres serve as a physical support for the growing of these grown microorganisms.

The internal, porous and draining layer (1) comprises here a small proportion, between 2 and 5% of 10%, of a biodegradable fibre, preferably slowly biodegradable, like a hemp or coco fibre. By “slowly biodegradable fibre”, this means fibres which are totally degraded by organisms in the environment (for example, the grown plant, fungus and/or microorganism, and/or ambient or added microorganisms) over 10 months old, preferably over 20 months old, but preferably also less than 60 months old. The presence of these fibres increases the fungi and/or microorganism biomass in the porous support of the invention.

Fibres forming the porous, draining layers 1 and 2 of the walls 4 and 4′ of the support 5 can be weaved or knitted, or again form a non-woven textile and/or a meshed network. These layers 1 and 2 therefore have a certain thickness and an internal porosity; their structure is continuous and non-perforated. Thus, even if the porous, draining layers 1 and 2 are made from polyolefins, they differ from a perforated plastic, made from polyolefins; their thickness and their porosity allow the roots 12 of the plant to cling on to, in and/or between the porous, draining layers 1 and 2.

The layers 1 and 2 produced contain a large number of gaps. These pores allow water and air to circulate. Thus, these layers 1 and 2 are not, or are not very, hygroscopic.

The porous, draining support 5 of this application, is good for growing an organism, this includes a plant organism, because it contains significantly more atmospheric oxygen and allows a better colonisation by the root system, as well as a colonisation by the fungi and/or microorganisms.

This colonisation does not prevent the draining of irrigation water, even over time, in other word, a significant proportion of pores remains, the pores not being obstructed because of this colonisation.

A vertical support 5 has been considered. It can also be tilted vertically, so that the irrigation water flows under the effect of gravity.

The different layers of the walls 4, 4′ are assembled on top of each other by known means, such as sewing or stapling. These layers can be connected 1) at their ends (top, bottom) or on their lateral periphery, 2) at the points of mechanical tension around the pocket 31 (particularly at the bottom and at the top) where the plant 11 to be grown is located, or 3) over the whole of their surface.

In reference to FIG. 3, the growing support 6 only comprises one single wall 14. The wall 14 is substantially horizontal. It comprises a top layer 41 which is porous, mainly inert, and draining. Its characteristics are the same as those of the internal layer 1 of the support 5 in FIGS. 1 and 2, with the same provisions and the same options. The wall 14 comprises here a bottom layer 42, the same characteristics and options as the dividing layer 2 of the support 5 in FIGS. 1 and 2.

The support 6, however, does not comprise any organism receiving pocket, but the same organisms can be grown there as on the two-walled support 5. It is connected to a support device, shown here on the trestles 45 and irrigation water collector 46. The irrigation system is not represented in FIG. 3.

This invention allows the growing of aerobic fungi and/or microorganisms. This growing of aerobic fungi and/or microorganisms can, in practice, be a combined growing with plants, which allows a symbiosis at the level of the plant roots (the plant benefits from the fungus and/or the microorganism, and vice versa), or again, modify the secondary metabolism of the plant, even the fungus and/or microorganism up to optimising the production of desired metabolites.

The method of purifying biological waste consists of preparing a growing support with one or two walls, such as, preferably, a growing support containing the porous layer comprising biodegradable fibres, seeding this support with plants and/or (aerobic) fungi and/or (aerobic) microorganisms, and irrigating this seeded support with biological waste. This waste, which can comprise one or several peptides and/or metabolites of it, nucleic acids and/or metabolites of it, polysaccharides and/or metabolites of it, must be compatible with the metabolism of the organisms grown on this support, or made compatible with the metabolism of the organisms grown. For example, the biological waste to be purified can be diluted or mixed with other biological waste and/or other nutrients so that its different components correspond to the metabolism of the species grown (nitrogenous compound content, sugar content, mineral content). The possible presence of toxic compounds for the (combined) growth, should be controlled, and, if needed, adapted (selective extraction, dilution of the composition, adjustment of pH level). A person skilled in the art is able to adapt the flow of waste, so as to maintain the (combined) growth over time, while eliminating (biological) waste as much as possible because of the metabolism of the grown organisms.

1. Porous support for growing an organism, comprising two walls capable of receiving water, the two walls being designed to form at least one pocket for receiving the organism wherein each wall comprises at least one porous layer comprising a chemically inert and porous material allowing water to flow under the effect of gravity through the pores of the layer, the said layer being designed to allow the organism to cling on to it.

2. Porous support according to claim 1, wherein the porous layer further comprises biodegradable fibres.

3. Porous support according to claim 2, wherein the porous layer comprises 2 to 10% in mass of the biodegradable fibres.

4. Porous support according to claim 2, wherein the biodegradable fibres come from one of the plants of the plant group comprising hemp and coco.

5. Porous support according to claim 1, wherein the porous layer allowing the organism to cling on to it, is an internal layer and each wall further comprises an external protective layer.

6. Porous support according to claim 5, wherein a dividing, porous and inert layer is provided in each wall.

7. Porous support to grow an organism with one single wall substantially horizontal, which can hold water, comprising a chemically inert and porous material allow water to flow under the effect of gravity through the pores of the layer, the said porous layer being designed to allow the organism to cling on to it.

8. Porous support according to claim 2, wherein the porous layer further comprises biodegradable fibres.

9. Porous support according to claim 1, wherein the inert and porous material comprises a polyolefin, preferably polypropylene.

10. Use of the porous support according to claim 1 to grow plants fertilised by organic fertilisers.

11. Use of the porous support according to claim 1 to grow cells chosen among aerobic bacteria, aerobic fungi and mixtures of these.

12. Method for growing aerobic bacteria and/or aerobic fungi comprising:
the preparation of a porous support according to claim 1,
the seeding of the said bacteria and/or the said fungi and
the adding of a growing environment comprising water and organic nutrients.

13. Method according to claim 12, wherein the organic nutrients mainly come from waste.

14. Method for purifying a composition comprising organic compounds that come from biological waste comprising:
the preparation of a porous support according to claim 1,
the seeding of the said porous support with aerobic bacteria and/or aerobic fungi and/or plants and
the adding the said composition to be purified to the said seeded support.
